(19) United States
(12) Patent Application Publication
(10) Pub. No.: US 2013/0136411 A1
(43) Pub. Date: May 30, 2013

(54) TIME-SHIFTED CONTENT CHANNELS

(71) Applicants: Tim Herby, Los Altos, CA (US); Alan Merzon, San Jose, CA (US); Christopher Habliston, San Jose, CA (US); Antonio Fontan, San Jose, CA (US); Sascha Prueter, San Francisco, CA (US)

(72) Inventors: Tim Herby, Los Altos, CA (US); Alan Merzon, San Jose, CA (US); Christopher Habliston, San Jose, CA (US); Antonio Fontan, San Jose, CA (US); Sascha Prueter, San Francisco, CA (US)

(73) Assignee: MICROSOFT CORPORATION, Redmond, WA (US)

(21) Appl. No.: 13/305,608

(22) Filed: Nov. 28, 2011

(51) Int. Cl. H04N 5/775; H04N 9/80

(52) U.S. Cl. 386/230; 386/241; 386/E05.07; 386/E09.011

(57) ABSTRACT

A method for managing time-shifted media content is provided. The method comprises associating one or more title-independent selection criteria with a time-shifted content channel. For each time-shifted content channel, one or more time-shifted media content items that satisfy that time-shifted content channel's title-independent selection criteria may be added to that time-shifted content channel, and channel-identifying metadata may be associated with each time-shifted media content item in the time-shifted content channel.

### BACKGROUND

Typical digital video recorders present recorded video content to a viewer via one or more menus or lists of programs. The viewer then navigates through the series of menus to select a media content item to view. This experience does not resemble a traditional channel surfing paradigm.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Embodiments for managing time-shifted media content are provided. In one example, a method includes associating one or more title-independent selection criteria with a time-shifted content channel. For each time-shifted content channel, one or more time-shifted media content items that satisfy that time-shifted content channel's title-independent selection criteria may be added to that time-shifted content channel. Channel-identifying metadata may be associated with each time-shifted media content item in the time-shifted content channel.

### BRIEF DESCRIPTION OF THE DRAWINGS

FIG. 1 shows an example content viewing environment according to an embodiment of the present disclosure.

FIG. 2 shows a flow chart illustrating a method for managing time-shifted media content according to an embodiment of the present disclosure.

FIG. 3 shows a flow chart illustrating a method for presenting time-shifted media content according to an embodiment of the present disclosure.

FIG. 4 shows an example display device illustrating various mechanisms of presenting time-shifted content channels according to an embodiment of the present disclosure.

FIG. 5 schematically shows an example computing system.

### DETAILED DESCRIPTION

Navigating through previously recorded video content items may be a “lean forward” experience for a viewer, as the viewer is often presented with a series of menus from which to select the content he or she wishes to view. Viewing of broadcast video content, on the other hand, tends to be a “lean back” experience, wherein the viewer can naturally browse and sample the presented content. To provide a more lean back experience with recorded content, customized time-shifted content channels may be assembled based on one or more content-specific criteria. These channels may be visually presented to the viewer side-by-side with conventional channels, thus allowing a viewer to navigate the time-shifted content channels in the same way as conventional channels. Additionally or alternatively, the time-shifted content channels may be visually presented as a list of nested groups side-by-side with other time-shifted content that is not organized into customized time-shifted content channels. In doing so, the time-shifted content channels may organize time-shifted media content items into “smart lists” of content customized for a particular viewer, while allowing presentation of the smart lists in a more traditional, lean back manner.

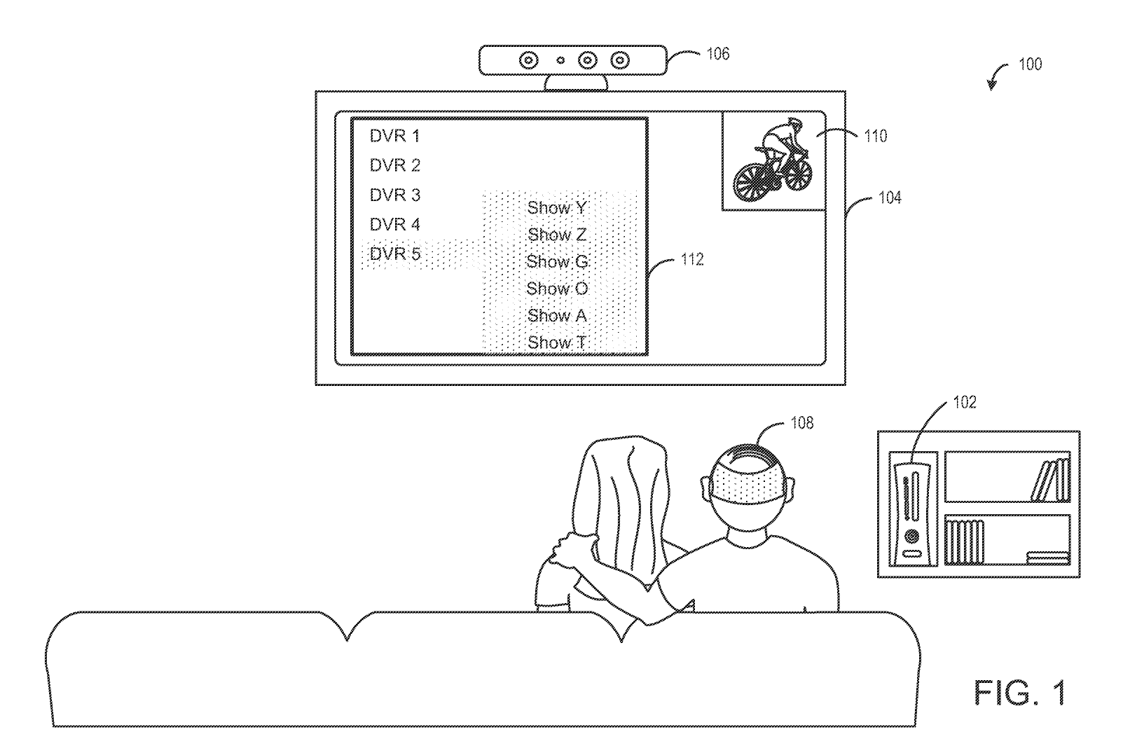

FIG. 1 shows a non-limiting example of time-shifted media content viewing environment 100 in the form of a computing system 102, a display device 104, and one or more optional sensors 106. The display device 104 may be operatively connected to the computing system 102 via a wireless or wired display output of the computing system. For example, the computing system may include an HDMI or other suitable display output. The display device 104 as shown in FIG. 1 is in the form of a high definition television, which may be used to present media content to a viewer 108. While depicted as separate elements in the embodiment of FIG. 1, in some embodiments, the computing system 102, display device 104, and/or sensor 106 may integrated into a single, common device.

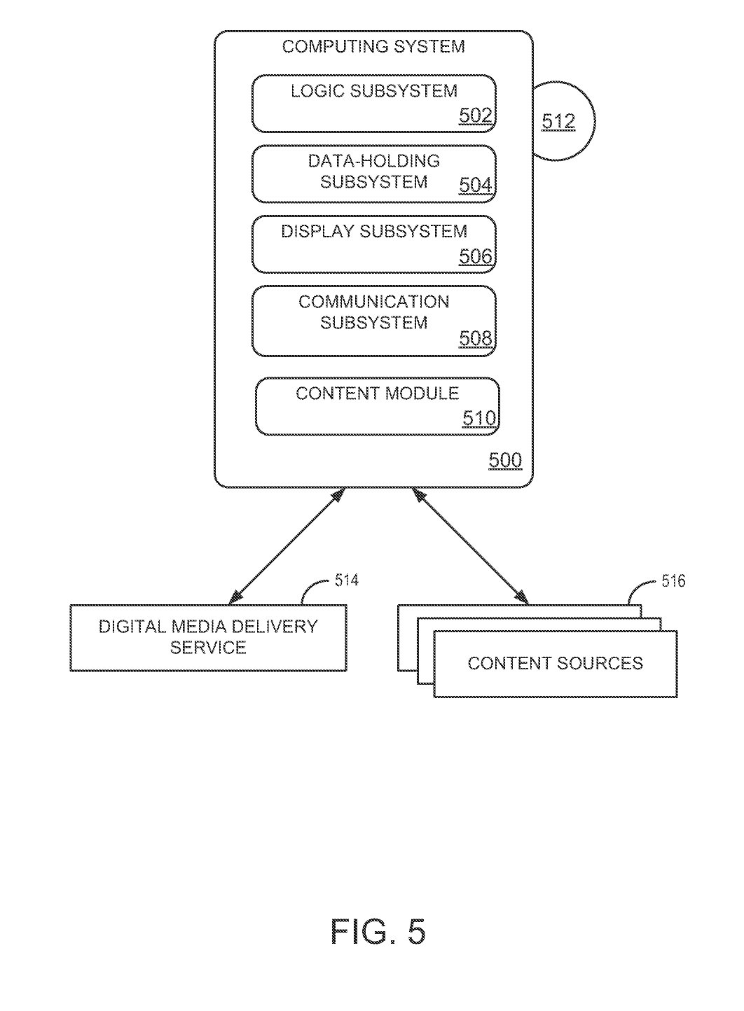

The computing system 102 is configured to receive and record media content items from one or more content providers. A media content item may include virtually any audio-visual content, such as a television show, a webcast, a radio show, or a movie, for example. The media content items may be delivered to the computing system 102 via any suitable transmission mechanism, including but not limited to over-the-air broadcasts, cable broadcasts, satellite broadcasts, and/or Internet broadcasts. Content providers may provide such content items for free, as part of a subscription package, on an ‘on demand’ basis, or via virtually any other distribution model. The computing system 102 may receive media content directly from a content provider, or may receive media content through a third party, such as a digital media delivery service. An example digital media delivery service 514 is depicted in FIG. 5 and discussed in more detail below. Additionally, the computing system may be configured to retrieve media content items that are available for on-demand delivery from a remote service. It should be appreciated that the content items may be received from more than one content provider.

The media content items received at the computing system may be stored for later playback. As used herein, the term “time-shifted media content” may refer to media content that has been previously recorded, is available on-demand from a remote service, or may otherwise be viewed at a starting time chosen by the viewer as opposed to a fixed starting time that cannot be changed by the viewer. More detailed information regarding the computing system will be presented with respect to FIG. 5.

The computing system 102 may be configured to present the time-shifted media content in one or more time-shifted content channels. Time-shifted content channels may include time-shifted media content items that have been grouped together based on one or more selection criteria. These time-shifted content channels may include time-shifted media content items that are related in various ways, and may include a sports channel, movie channel, recommended by a friend channel, etc. The time-shifted media content items may be grouped into the time-shifted content channels based on criteria selected by a viewer, rather than being grouped together by the content provider that originally broadcast the media content, as traditional live television channels are organized. As such, a time-shifted content channel may include time-shifted media content items from different content providers and/or different broadcast channels within those providers. The time-shifted content channels may be arranged together in a guide and visually displayed to a viewer. The viewer may then select time-shifted media content to view from the guide.

An example time-shifted media content item 110 is presented on display device 104. Additionally, an example guide of time-shifted content channels is presented on display device 104. In the embodiment depicted in FIG. 1, the guide is in the form of a nested list 112 of content channels. When the nested list 112 is presented on the display device, the time-shifted media content item 110 optionally may be viewed as a “picture in picture” (PIP) to give the viewer a preview of the time-shifted media content item. In other embodiments, a PIP may be used to display the last program that was viewed prior to viewing the nested list 112 of time-shifted content channels. In some embodiments, the nested list 112 may be superimposed over a preview and/or a last program viewed.

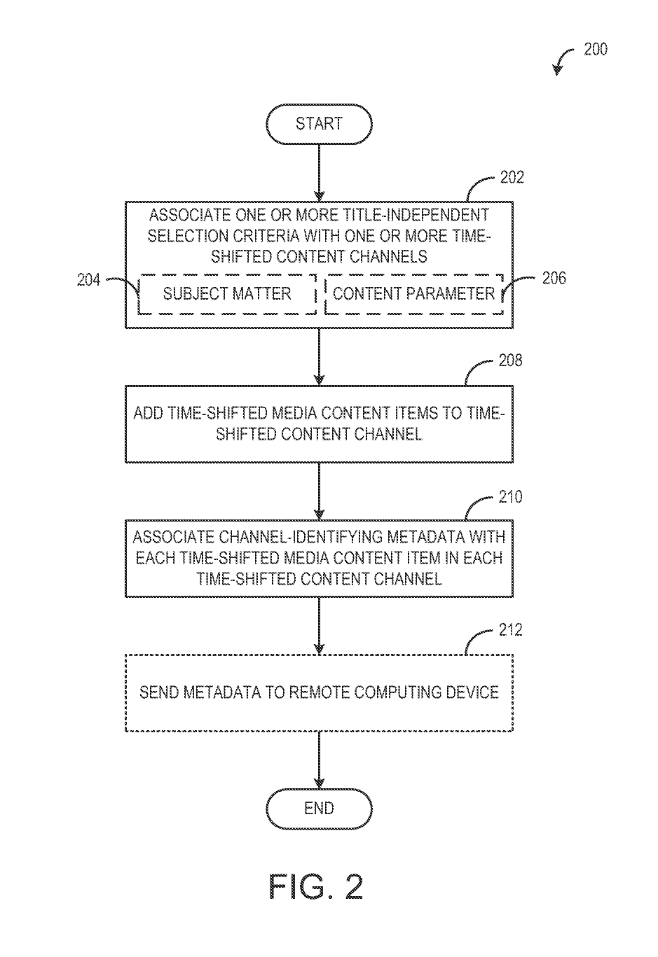

FIG. 2 illustrates a method 200 for managing time-shifted video content. FIG. 2 may be carried out by one or more remote devices that are configured to send media content information to the computing system 102, such as a digital media delivery service, for example. Method 200 comprises, at 202, associating one or more title-independent selection criteria with one or more time-shifted content channels. The selection criteria may be used to sort the time-shifted media content items into the time-shifted content channels, independent of the title of the media content. Additionally, in some embodiments, the media content items may be sorted based on title-dependent selection criteria in addition to the one or more title-independent selection criteria. As used herein, “title” may refer to the name of the media content item as determined by the original broadcaster and/or content creator. When the media content item is an episode of a multi-episode series, the title of that media content item may also include the title of the entire series.

The selection criteria used to sort the time-shifted media content items into the time-shifted content channels may be selected in any suitable manner. In some embodiments, the digital media delivery service may automatically select which criteria to use to sort the time-shifted media content items. In other embodiments, a viewer may wish to view customized time-shifted content channels, in which case the viewer may select which criteria to use to sort the time-shifted media content items into customized time-shifted content channels.

The selection criteria may include subject matter criteria at 204 and/or content parameter criteria at 206, among others. In one embodiment, the subject matter criteria may include criteria that relates to the subject matter of the time-shifted media content, such as genre, director of the media content, actor performing in the media content, type of media content, etc. The content parameter criteria may include criteria that relates to aspects of the content other than the actual subject matter, such as the air date, format, language, etc. The content parameter criteria may also include the mechanism by which the time-shifted media content was sent to the computing system, such as the content provider, or an outside, third party that recommended the media content be recorded. A content provider may include an entity that produced the media content item, such as television studio, a broadcast channel that broadcast the media content item, or a source of the media content item, such as an on-demand source or cable provider, etc.

The selection criteria may be used to add the time-shifted media content items into a corresponding time-shifted content channel at 208. For example, a time-shifted content channel may include time-shifted media content that meets a specific criteria, such as comedy shows airing in high-definition. All time-shifted media content items that meet that criteria may be added to that time-shifted content channel. Additionally, the time-shifted media content items in that time-shifted content channel may be further sorted based on air date, likelihood viewer will watch the media content item (as based on past viewing history), etc.

At 210, method 200 comprises associating content-channel identifying metadata with each time-shifted media content item in each time-shifted content channel. The content-channel identifying metadata can be used by a device, such as the computing system 102, to group otherwise unrelated time-shifted media content items. For example, a user interface can visually present the time-shifted media content items grouped together in their corresponding time-shifted content channels.

At 212, method 200 optionally comprises sending the metadata to a remote computing device, such as computing system 102 of FIG. 1. The channel-identifying metadata associated with each time-shifted media content item may be useable by the remote computing device to enable a more traditional, lean-back “channel surfing” paradigm for a user. For example, a user may select a time-shifted content channel for display on a display device. Similar to channel surfing of typical, broadcast content channels, the user may skip between various time-shifted media content items within the time-shifted content channel, without intervening menu selections.

In one example, the channel-identifying metadata associated with each time-shifted media content item may be useable by the remote computing device to stop playing a first time-shifted media content item and automatically start playing a second time-shifted media content item responsive to a channel navigation command. That is, in response to an input selection by a user such as a next program command, the first time-shifted media content item, which is currently being displayed on the display device, may stop playing and the second time-shifted media content item may begin playing. This may more closely resemble a traditional channel surfing experience, even with time-shifted media content items.

The channel navigation command may be virtually any command input by a viewer that results in navigation through the time-shifted media content. Example channel navigation commands include next program and previous program commands, which may navigate to different items of time-shifted media content within a single time-shifted content channel. Other example channel navigation commands include channel up and channel down commands, which may navigate to different items of time-shifted media content within different time-shifted content channels. Additionally, other inputs, such as diagonal change commands and direct input commands, are also possible.

According to method 200, a time-shifted media content item may be tagged with content-channel identifying metadata in addition to any other metadata that accompanies the media content item from the content provider. All time-shifted media content items within a particular time-shifted content channel will include at least one common metadata tag. For example, a set of time-shifted media content items related to baseball may be tagged with a metadata tag indicating that the media content item is related to baseball. All time-shifted baseball related media content items with this metadata tag may be placed into the same time-shifted content channel. As such, a customized time-shifted baseball channel with time-shifted baseball related content from a variety of different content providers and/or channels may be presented side-by-side with conventional channels. As each time-shifted media content item may have more than one tag, in some embodiments, some time-shifted media content items may appear in multiple time-shifted content channels. In other embodiments, some time-shifted media content items may not be assigned to any time-shifted content channels, for example, if the selection criteria for each time-shifted content channel to do not apply to that item of time-shifted media content.

In the embodiment depicted in FIG. 2, the time-shifted content channels are assembled remotely from the device which will ultimately present the time-shifted media content items for viewing on a display device. However, in some embodiments, the time-shifted media content items may be grouped into the time-shifted content channels via an application that is executed locally on the device which will present the time-shifted media content items, such as an application executed on computing system 102.

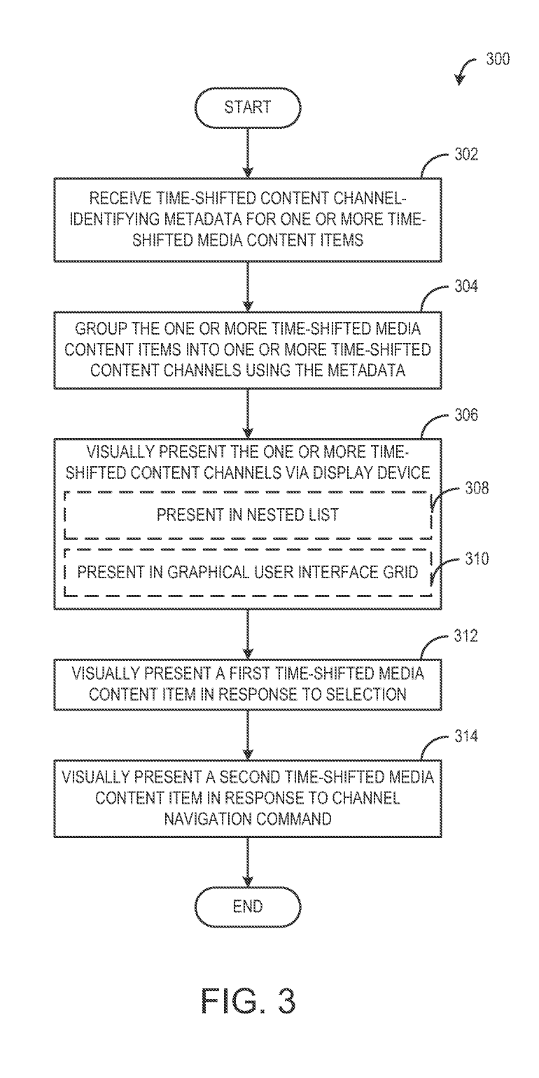

FIG. 3 illustrates a method 300 for presenting time-shifted content channels. Method 300 may be carried out by a device configured to store media content items and present the media content items via a display device, such as computing system 102.

At 302, method 300 comprises receiving time-shifted content channel-identifying metadata for one or more time-shifted media content items. The time-shifted content channel-identifying metadata may be bundled with the media content items and/or received separately with an identifier for linking it to the appropriate time-shifted media content item. As explained above with respect to FIG. 2, the content channel-identifying metadata may be used to tag the time-shifted media content in order to place the time-shifted media content items into time-shifted content channels. The time-shifted media content items may be tagged with title-independent metadata tags so that the time-shifted content channels may be based on criteria other than the title of the time-shifted media content item. These metadata tags may be based on selection criteria including both subject matter criteria, such as genre, and content parameter criteria, such as air date. At 304, method 300 includes grouping the one or more time-shifted media content items into one or more time-shifted content channels using the content-channel identifying metadata.

The one or more time-shifted content channels may be visually presented via a display device at 306. The visual presentation of the content channels may be carried out in a variety of ways. In one example, the time-shifted content channels may be presented in a nested list at 308. Each time-shifted content channel in the nested list may be expandable to reveal those time-shifted media content items grouped into that time-shifted content channel. An example nested list of content channels is depicted as nested list 112 of FIG. 1. Referring to the nested list 112 of FIG. 1, a list of time-shifted content channels, named “DVR1-5” in the depicted embodiment, may be presented in a list. By selecting a particular time-shifted content channel, such as DVR 5, the time-shifted media content items in that channel may be displayed, herein depicted as Shows Y, Z, G, O, A, and T. A particular time-shifted media content item, such as Show Y, may be selected for viewing on the display device. Additionally or alternatively, selecting a different time-shifted content channel from the nested list will result in the time-shifted media content items of the newly-selected time-shifted content channel being displayed instead of the time-shifted media content items of the originally-selected time-shifted content channel.

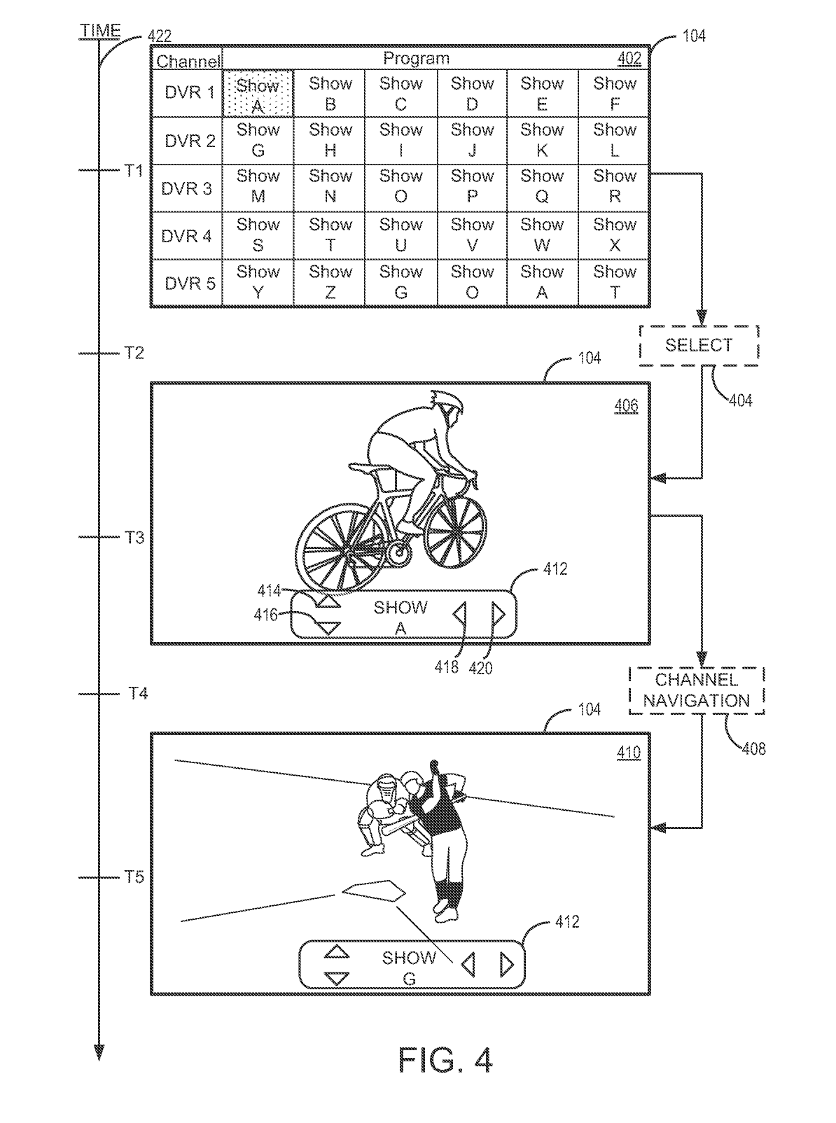

In other embodiments, the time-shifted content channels may be presented in a graphical user interface grid at 310. The graphical user interface grid may include each time-shifted content channel arranged along one axis of the grid, and the one or more time-shifted media content items aligned with their respective time-shifted content channels along another axis of the grid. An example grid is depicted in FIG. 4. FIG. 4 shows an example display device 104 displaying a graphical user interface grid 402 presenting time-shifted content channels “DVR 1-5”. The time-shifted content channels are oriented along the vertical axis. Each item of time-shifted media content within a particular time-shifted content channel, e.g., Show A-Show F of time-shifted content channel DVR 1, is arranged along the horizontal axis aligned with its respective time-shifted content channel.

The grid 402, as well as the nested list 112, are configured to be navigable by a viewer using, for example, a remote control, voice control, natural user interface gestures, or other suitable input mechanism. The viewer may select time-shifted media content items from the nested list 112 or grid 402 to view on the display device 104 by using a channel or content item selection command. An example selection command is depicted at 404 of FIG. 4. Here, the viewer has entered a selection command, for example by inputting a selection button on a remote control device, speaking a select command to a voice recognition system, and/or performing a select gesture to a gesture recognition system. The computing system is then sent a request to send that time-shifted media content item to the display device 104. Show A, which is a first time-shifted media content item 406, is displayed in response to the selection command 404.

Returning to FIG. 3, displaying the time-shifted content channels optionally further includes visually presenting a time-shifted media content item on the display device. Thus, at 312, method 300 includes visually presenting a first time-shifted media content in response to a selection. The first time-shifted media content item may be displayed in response to a viewer selection command from the nested list or grid, as described above with respect to the selection command of FIG. 4. The first time-shifted media content item may alternatively or additionally be displayed in response to an automatic selection without a viewer command, such as a hardware event. In one example, a hardware event may include powering up the computing system and/or display device.

At 314, a second time-shifted media content item is visually presented in response to a channel navigation command. To present the second time-shifted media content item, the first time-shifted content item may stop being presented and instead the second time-shifted media content item may be presented. Returning to FIG. 4, Show G, a second time-shifted media content item 410, is presented via display device 104, in response to a channel navigation command at 408, such as the channel down command. The channel navigation command may be a one-button input to a remote control or other input device, a spoken word, and/or a physical gesture, for example.

The channel navigation command may be initiated by the viewer via the nested list 112 or grid 402. In other embodiments, the channel navigation command may be initiated while the viewer is watching the first time-shifted media content item, and the second time-shifted media content item may be displayed without an intervening display of the nested list 112 or grid 402. In other words, according to the present disclosure, a viewer may channel surf from one time-shifted media content item to another time-shifted media content item without using either a grid or nested list, or other such guides.

The first and second time-shifted media content items may have any suitable relationship to each other. In some embodiments, the first time-shifted media content item and the second time-shifted media content item may be grouped together in a time-shifted content channel. In this embodiment, the channel navigation command 408 may be a time-shifted media content change command that advances from the first time-shifted media content item to the second time-shifted media content item within the same time-shifted content channel. This may include a next program command or a previous program command, for example. In other embodiments, the first time-shifted media content item and the second time-shifted media content item may be grouped in different time-shifted content channels. As such, the channel navigation command 408 may be a channel change command, such as a channel up or channel down command, that advances from the first time-shifted media content item to the second time-shifted media content item, which is grouped in a different time-shifted content channel than the first media time-shifted content item, as depicted in FIG. 4. Further, in other embodiments, selection of the channel navigation command may result in replacement of display of a time-shifted media content item with a display of a media content item from a standard, broadcast channel (e.g., a non-time-shifted content channel). This may result when the broadcast channel is arranged adjacent to the time-shifted content channel in the nested list or grid, for example. In this way, broadcast channels may be navigated by a user along with the time-shifted content channels.

Upon presenting the one or more time-shifted content channels via the display device, as one or more of a nest list, grid, or actual time-shifted media content item, method 300 ends.

FIG. 4 shows an example display device 104 displaying time-shifted content channels according to various embodiments of the present disclosure. A timeline 422 shows an order of operations in FIG. 4. As explained above, a graphical user interface grid 402 presenting time-shifted content channels “DVR 1-5” is displayed at time T1. A viewer may select one of the time-shifted media content items to view by entering a selection command 404 at T2. In the illustrated embodiment, Show A has been selected. While not shown in FIG. 4, a time-shifted media content item may be displayed in the background behind the grid, or in a “picture in picture” next to the grid.

In response to the user selection of Show A, Show A may be presented on display device 104 at T3 as a first time-shifted media content item 406. In addition to Show A, the display device may also present a menu bar 412 for a predetermined amount of time following the start of the time-shifted media content item. The menu bar 412 may include information about the time-shifted media content item and/or indicate various available channel navigation commands. For example, the menu bar 412 indicates available channel up and down commands 414, 416 as well as previous program and next program commands 418, 420. The menu bar 412 depicted in FIG. 4 is non-limiting, and virtually any menu bar, or no menu bar, may be displayed along with the time-shifted media content item. In some embodiments, the display device may not display a menu bar, but may automatically respond to viewer commands.

A channel navigation command 408 is entered at T4. The channel navigation command 408 may be any command available to the user that results in a shift of the displayed content, such as the channel down command 416. In response, the computing system may advance to a time-shifted media content item in another time-shifted content channel if the channel navigation command is a channel change command such as the channel down command 416, or to another time-shifted media content item within the same time-shifted content channel if the channel navigation command is a program change command, such as the next program command 420.

At time T5, display device 104 displays another time-shifted media content item, Show G, as a second time-shifted media content item 410. The display of Show G may be in response to the channel navigation command 408 entered while watching Show A. In this embodiment, Show G is arranged below Show A in the grid 402 and appears subsequent to Show A when the channel down command 416 is entered by the viewer. However, any suitable command could result in any suitable time-shifted media content item being displayed. For example, if the viewer entered a next program command 420 while watching Show A, Show B may be displayed instead, as it is arranged to the right of Show A on the grid 402.

While the channel navigation command embodiments described herein generally refer to an input from a viewer into a device such as a remote control device, any suitable viewer input could indicate a program change. For example, as depicted in FIG. 1, the computing system 102 may be connected to one or more sensors 106. The sensor 106 may be able to sense a movement or action performed by the viewer, and send information to the computing system 102 to indicate a channel navigation command. Example actions include a viewer speaking, such as saying the command “channel down”, or may include the viewer raising his or her hand, etc. In some embodiments, the sensor 106 may be a depth camera configured to track and interpret the movements of the viewer.

When the computing system 102 receives a command to send a particular item of time-shifted media content to the display device, it may begin displaying that time-shifted media content item from the start of the time-shifted media content item. However, if the time-shifted media content item has been viewed previously, the time-shifted media content item may resume playing from where the last viewing ended.

In order to facilitate browsing, a time-shifted media content item may not be considered “viewed” unless it has been displayed for a threshold amount of time, such as 15 seconds. As such, a time-shifted media content item may start from its beginning even if a viewer previously browsed the time-shifted media content item for a few seconds.

Various browsing logics may be implemented without departing from the scope of this disclosure. As one example, when a channel navigation command is entered that indicates a change to the next time-shifted content channel, the first time-shifted media content item in that time-shifted content channel may be displayed, regardless of which time-shifted media content item of the first time-shifted content channel was originally viewed. For example, if Show V of channel DVR 4 is originally viewed, and the viewer enters a command to change to the channel DVR 5, Show Y may begin playing. Alternatively, an adjacent time-shifted media content item from a guide may be displayed. For example, if Show V is originally viewed and the viewer enters a command to change the channel to DVR 5, Show O may begin playing.

A time-shifted content channel may automatically play one time-shifted media content item after the other without user intervention. For example, if Show V reaches its end, Show W may automatically begin without further user input. In this way, different time-shifted media content items may play in series, even if such time-shifted media content items were received from different television channels and/or content providers.

While the embodiment depicted in FIG. 4 shows only time-shifted content channels within grid 402, it is to be understood that the grid 402 may display time-shifted content channels along with traditional television channels. For example, the time-shifted content channels may be grouped together and displayed in the grid 402 prior to or following a listing of traditional, live broadcast, television channels. In other embodiments, the time-shifted content channels may be integrated within the grid 402 along with traditional channels. Virtually any method of displaying the time-shifted content channels and traditional channels within the grid 402 is within the scope of this disclosure. Furthermore, nested list 112 may display time-shifted content channels with traditional, live broadcast, television channels.

In some embodiments, the above described methods and processes may be tied to a computing system including one or more computers. In particular, the methods and processes described herein may be implemented as a computer application, computer service, computer API, computer library, and/or other computer program product.

FIG. 5 schematically shows a nonlimiting computing system 500 that may perform one or more of the above described methods and processes. Computing system 102 of FIG. 1 is a nonlimiting example of such a computing system. Computing system 500 is shown in simplified form. It is to be understood that virtually any computer architecture may be used without departing from the scope of this disclosure. In different embodiments, computing system 500 may take the form of a mainframe computer, server computer, desktop computer, laptop computer, tablet computer, home entertainment computer, network computing device, mobile computing device, mobile communication device, gaming device, etc.

Computing system 500 includes a logic subsystem 502 and a data-holding subsystem 504. Computing system 500 may optionally include a display subsystem 506, communication subsystem 508, and/or other components not shown in FIG. 5. Computing system 500 may also optionally include user input devices such as remote controls, keyboards, mice, game controllers, cameras, microphones, and/or touch screens, for example.

Logic subsystem 502 may include one or more physical devices configured to execute one or more instructions. For example, the logic subsystem may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

The logic subsystem may include one or more processors that are configured to execute software instructions. Additionally or alternatively, the logic subsystem may include one or more hardware or firmware logic machines configured to execute hardware or firmware instructions. Processors of the logic subsystem may be single core or multicore, and the programs executed thereon may be configured for parallel or distributed processing. The logic subsystem may optionally include individual components that are distributed throughout two or more devices, which may be remotely located and/or configured for coordinated processing. One or more aspects of the logic subsystem may be virtualized and executed by remotely accessible networked computing devices configured in a cloud computing configuration.

Data-holding subsystem 504 may include one or more physical, non-transitory, devices configured to hold data and/or instructions executable by the logic subsystem to implement the herein described methods and processes. When such methods and processes are implemented, the state of data-holding subsystem 504 may be transformed (e.g., to hold different data).

Data-holding subsystem 504 may include removable media and/or built-in devices. Data-holding subsystem 504 may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. Data-holding subsystem 504 may include devices with one or more of the following characteristics: volatile, nonvolatile, dynamic, static, read/write, read-only, random access, sequential access, location addressable, file addressable, and content addressable. In some embodiments, logic subsystem 502 and data-holding subsystem 504 may be integrated into one or more common devices, such as an application specific integrated circuit or a system on a chip.

FIG. 5 also shows an aspect of the data-holding subsystem in the form of removable computer-readable storage media 512, which may be used to store and/or transfer data and/or instructions executable to implement the herein described methods and processes. Removable computer-readable storage media 512 may take the form of CDs, DVDs, HD-DVDs, Blu-Ray Discs, EEPROMs, and/or floppy disks, among others.

It is to be appreciated that data-holding subsystem 504 includes one or more physical, non-transitory devices. In contrast, in some embodiments aspects of the instructions described herein may be propagated in a transitory fashion by a pure signal (e.g., an electromagnetic signal, an optical signal, etc.) that is not held by a physical device for at least a finite duration. Furthermore, data and/or other forms of information pertaining to the present disclosure may be propagated by a pure signal.

The terms “module,” “program,” and “engine” may be used to describe an aspect of computing system 500 that is implemented to perform one or more particular functions. In some cases, such a module, program, or engine may be instantiated via logic subsystem 502 executing instructions held by data-holding subsystem 504. It is to be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” are meant to encompass individual or groups of executable files, data files, libraries, drivers, scripts, database records, etc.

It is to be appreciated that a “service”, as used herein, may be an application program executable across multiple user sessions and available to one or more system components, programs, and/or other services. In some implementations, a service may run on a server responsive to a request from a client.

When included, display subsystem 506 may be used to present a visual representation of data held by data-holding subsystem 504. As the herein described methods and processes change the data held by the data-holding subsystem, and thus transform the state of the data-holding subsystem, the state of display subsystem 506 may likewise be transformed to visually represent changes in the underlying data. Display subsystem 506 may include one or more display devices utilizing virtually any type of technology. Such display devices may be combined with logic subsystem 502 and/or data-holding subsystem 504 in a shared enclosure, or such display devices may be peripheral display devices.

When included, communication subsystem 508 may be configured to communicatively couple computing system 500 with one or more other computing devices. Communication subsystem 508 may include wired and/or wireless communication devices compatible with one or more different communication protocols. As nonlimiting examples, the communication subsystem may be configured for communication via a wireless telephone network, a wireless local area network, a wired local area network, a wireless wide area network, a wired wide area network, etc. In some embodiments, the communication subsystem may allow computing system 500 to send and/or receive messages to and/or from other devices via a network such as the Internet.

Content module 510 may receive media content from a variety of sources, such as satellite, cable, over-the-airwaves broadcast, the Internet, etc. Content module 510 may be connected to one or more external tuners (not shown) that receive the media content and translate it into a format understandable by the computing system 500 (e.g., translate encrypted video into unencrypted MPEG 4). Content module 510 may also include an output configured to output the media content to the display subsystem 506.

Computing system 500 may be configured to receive media content items for later playback from a variety of content sources 516. Computing system may also receive media content items from digital media delivery service 514. Digital media delivery service 514 may communicate with computing system 500 directly, or through one or more networks such as the Internet. Digital media delivery service 514 may be configured to send metadata associated with the time-shifted media content items in order to group the time-shifted media content items into the time-shifted content channels. Digital media delivery service 514 may also store viewer profile information. The viewer profile information may include time-shifted content channels associated with that viewer, past viewing history, timestamps that indicate the point at which the viewer stopped watching a particular time-shifted media content item, etc. This viewer profile information may allow a viewer to watch selected time-shifted content channels from more than one computing system, and may allow the time-shifted content channels to be customized to that viewer.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A method for managing time-shifted media content, comprising:
associating one or more title-independent selection criteria with a time-shifted content channel;
for each time-shifted content channel, adding to that time-shifted content channel one or more time-shifted media content items that satisfy that time-shifted content channel's title-independent selection criteria; and
associating channel-identifying metadata with each time-shifted media content item in the time-shifted content channel.

2. The method of claim 1, wherein the channel-identifying metadata associated with each time-shifted media content item is useable by a remote computing device to stop playing a first time-shifted media content item and automatically start playing a second time-shifted media content item responsive to a channel navigation command.

3. The method of claim 1, wherein the title-independent selection criteria comprises subject matter criteria.

4. The method of claim 1, wherein the title-independent selection criteria comprises content parameter criteria.

5. The method of claim 1, wherein the time-shifted media content items comprise previously recorded video content items.

6. The method of claim 1, wherein the time-shifted media content items comprise a video content item available for on-demand delivery from a remote service.

7. The method of claim 1, wherein the channel-identifying metadata is usable to group the time-shifted media content items from the time-shifted content channel together in a graphical user interface grid.

8. The method of claim 1, wherein the channel-identifying metadata is usable to group the time-shifted media content items from the time-shifted content channel together in a list of nested groups.

9. A data-holding subsystem holding instructions executable by a logic subsystem to:
receive time-shifted content channel-identifying metadata for one or more time-shifted media content items to group the one or more time-shifted media content items into one or more time-shifted content channels; and
present a nested list of the one or more time-shifted content channels, each time-shifted content channel in the nested list expandable to reveal those time-shifted media content items grouped into that time-shifted content channel.

10. The data-holding subsystem of claim 9, wherein the instructions are executable to visually present the nested list via a display device.

11. The data-holding subsystem of claim 10, wherein the instructions are executable to visually present a first time-shifted media content item via the display device in response to a selection of the first time-shifted media content item from the nested list.

12. The data-holding subsystem of claim 11, wherein the instructions are executable to stop visually presenting the first time-shifted media content item via the display device and instead visually present a second time-shifted media content item via the display device in response to a channel navigation command.

13. The data-holding subsystem of claim 11, wherein the first time-shifted media content item and the second time-shifted media content item are grouped together in a time-shifted content channel.

14. The data-holding subsystem of claim 11, wherein the first time-shifted media content item and the second time-shifted media content item are grouped in different time-shifted content channels.

15. The data-holding subsystem of claim 9, wherein the time-shifted content channel-identifying metadata comprises one or more title-independent selection criteria used to group the one or more time-shifted media content items into one or more time-shifted content channels.

16. The data-holding subsystem of claim 9, wherein the one or more time-shifted media content items comprise previously recorded video content items.

17. The data-holding subsystem of claim 9, wherein the one or more time-shifted media content items comprise video content items available for on-demand delivery from a remote service.

18. A data-holding subsystem holding instructions executable by a logic subsystem to:
receive time-shifted content channel-identifying metadata for one or more time-shifted media content items to group the one or more time-shifted media content items into one or more time-shifted content channels; and
present a graphical user interface grid in which each time-shifted content channel is arranged along one axis of the grid, and the one or more time-shifted media content items are aligned with their respective time-shifted content channels along another axis of the grid.

19. The data-holding subsystem of claim 18, wherein the time-shifted content channel-identifying metadata comprises one or more title-independent selection criteria used to group the one or more time-shifted media content items into one or more time-shifted content channels.

20. The data-holding subsystem of claim 18, wherein the one or more time-shifted media content items comprise previously recorded video content items.
